(19) United States
(12) Patent Application Publication
(10) Pub. No.: US 2003/0061383 A1
(43) Pub. Date: Mar. 27, 2003

(54) Predicting processor inactivity for a controlled transition of power states

(76) Inventor: Anthony M. Zilka, Portland, OR (US)

Correspondence Address: Peter Lam, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/964,822

(22) Filed: Sep. 25, 2001

(51) Int. Cl. G06F 15/16

(52) U.S. Cl. 709/245

(57) ABSTRACT

A method for predicting processor inactivity for a controlled transition of power states. The method of one embodiment comprises predicting a first event that allows for lower performance in a processor. The processor is transitioned from a high performance state to a low performance state upon prediction of the first event. A second event that can utilize greater performance in the processor is detected. The processor is transitioned from the low performance state to the high performance state upon detection of the second event.

### FIELD OF THE INVENTION

The present invention relates generally to the field of microprocessors and computer systems. More particularly, the present invention relates to a method and apparatus for predicting processor inactivity for a controlled transition of power states.

### BACKGROUND OF THE INVENTION

In recent years, the price of personal computers (PCs) have rapidly declined. As a result, more and more consumers have been able to take advantage of newer and faster machines. But as the speed of the new processors increases, so does the power consumption. Furthermore, high power consumption can also lead to thermal issues as the heat has to be dissipated from the computer system. And unlike desktop computers that are powered by an alternating current (AC) source, notebook computers usually run off a limited battery supply. If a mobile computer is operating at the same performance level as a desktop machine, the power is drained relatively quickly.

In order to extend battery life of mobile computers without widening the performance gap with desktop counterparts and to reduce the power consumption of desktop machines, computer manufacturers and designers have instituted power saving technology. One attempt to reduce power consumption entails the use of low power circuit devices. Another power saving method is to use software in controlling system power and shutting down system devices that are not needed. But even as designers slowly reduce the power needs of the overall system, the power requirements of the processor have often remained steady. New schemes have to be developed to target power reduction at the processor.

### BRIEF DESCRIPTION OF THE DRAWINGS

The present invention is illustrated by way of example and not limitations in the figures of the accompanying drawings, in which like references indicate similar elements, and in which:

FIG. 1 is a computer system utilizing one embodiment of a mechanism for predicting processor inactivity for a controlled transition of power states;

FIG. 2 is one embodiment of a system with a processor including a power control mechanism;

FIG. 3 is a diagram showing a controlled transition of power states; and

FIG. 4 is flow diagram of one embodiment illustrating the method of predicting processor for a controlled transition of power states.

### DETAILED DESCRIPTION

A method and apparatus for predicting processor inactivity for a controlled transition of power states is disclosed. The embodiments described herein are described in the context of a microprocessor, but are not so limited. Although the following embodiments are described with reference to a processor, other embodiments are applicable to other integrated circuits or logic devices. The same techniques and teachings of the present invention can easily be applied to other types of circuits or semiconductor devices that could utilize power savings and have idle circuits.

In the following description, for purposes of explanation, numerous specific details are set forth in order to provide a thorough understanding of the present invention. One of ordinary skill in the art, however, will appreciate that these specific details are not necessary in order to practice the present invention. In other instances, well known electrical structures and circuits have not been set forth in particular detail in order to not necessarily obscure the present invention.

Many of today's CPUs can spend a large amount of idle waiting for main memory accesses to complete. Since present day microprocessors consume significant amounts of power, the processor can be burning up valuable power simply being idle. This idle time can be spent in a lower power state, thus saving overall power dissipation. One of the problems with dynamically changing power states from full power to low power is predicting the state change. A power state change involves large changes in current that cannot be changed quickly. A sudden surge in the current whether from the decrease or increase of power can cause harmful results in the processor circuits and the power supply regulation.

A main memory access can be “predicted” based on misses in the cache. There already are existing signals indicating a main memory access is coming (cache miss). This prediction can be used to moderate the power state change and mitigate the impact of quick, large changes in the power delivery current. Furthermore, when the data is read back from the memory, the bus controller knows when the data is returning. The data generally returns from memory at a much slower clock rate than the processor core because the external bus frequency is much less than the processor frequency. As integrated circuit technology has progressed, current processors are now operating on the gigahertz (GHz) scale while memory is still not keeping up with the pace. Memories continue to operate within the megahertz (MHz) frequency range. This difference in frequency can be used to mitigate powering the processor back up to full power.

Dynamic power changes are presently done on a clock by clock state assessment in the processor. These power changes generally result in quick current transients. By using a cache miss as a predictor of an extended low power memory state, the transient current can be mitigated by slowing the power state transition. Similarly, the ‘high power’ state transition can also be moderated when the main memory data returns. The return of main memory data also takes a long time. This time can be used to moderate the current transient of the power state change back to full power.

Embodiments of the present invention can help lower the overall power dissipation of a processor. The system cost of cooling the processor may also be lowered as the processor in not continually operating at full power. Such a feature may be advantageous for processors in the low power, mobile market segment. Certain aspects of the system architecture can provide an indication of when the processor is going into and out of periods of relative inactivity. One embodiment of the invention uses existing signals, functional units, and state information to identify a low power state and to predict a power state change. The mechanism of one embodiment predicts early enough in time to implement a controlled power state change to mitigate current transients.

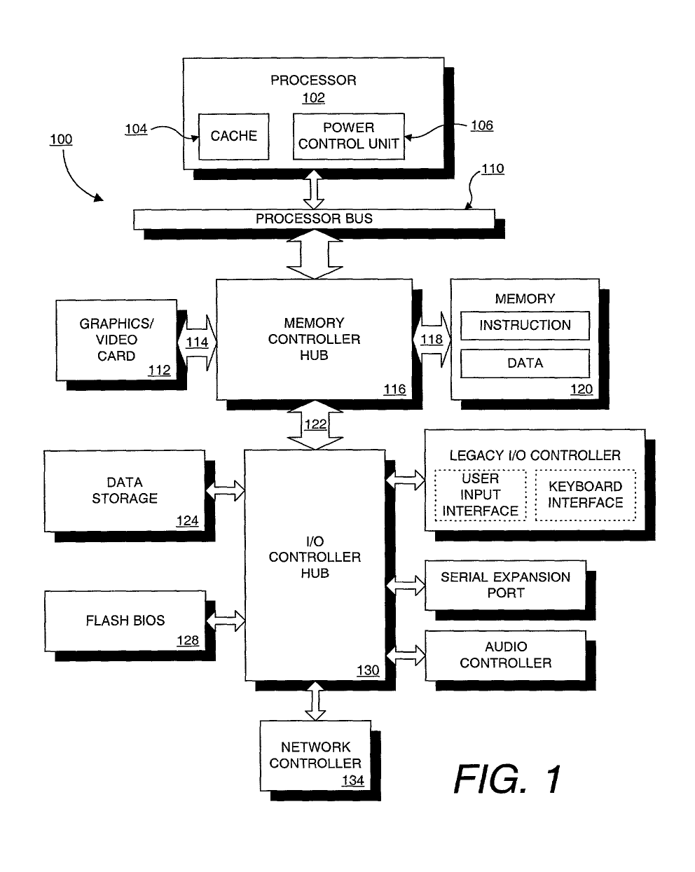

Referring now to FIG. 1, an exemplary computer system 100 is shown. System 100 includes a component, such as a processor, employing self initialization for charge pumps in accordance with the present invention, such as in the embodiment described herein. System 100 is representative of processing systems based on the PENTIUM® II, PENTIUM® III, PENTIUM® 4, Itanium™ microprocessors available from Intel Corporation of Santa Clara, Calif., although other systems (including PCs having other microprocessors, engineering workstations, set-top boxes and the like) may also be used. In one embodiment, sample system 100 may be executing a version of the WINDOWS™ operating system available from Microsoft Corporation of Redmond, Wash., although other operating systems and graphical user interfaces, for example, may also be used. Thus, the present invention is not limited to any specific combination of hardware circuitry and software.

The present enhancement is not limited to computer systems. Alternative embodiments of the present invention can be used in other devices such as, for example, handheld devices and embedded applications. Some examples of handheld devices include cellular phones, Internet Protocol devices, digital cameras, personal digital assistants (PDAs), and handheld PCs. Embedded applications can include a microcontroller, a digital signal processor (DSP), system on a chip, network computers (NetPC), set-top boxes, network hubs, wide area network (WAN) switches, or any other system which uses a latch type mechanism for other embodiments.

FIG. 1 is a block diagram of one embodiment of a system 100. System 100 is an example of a hub architecture. The computer system 100 includes a processor 102 that processes data signals. The processor 102 may be a complex instruction set computer (CISC) microprocessor, a reduced instruction set computing (RISC) microprocessor, a very long instruction word (VLIW) microprocessor, a processor implementing a combination of instruction sets, or other processor device, such as a digital signal processor, for example. FIG. 1 shows an example of an embodiment of the present invention implemented in a single processor system 100. However, it is understood that other embodiments may alternatively be implemented as systems having multiple processors. Processor 102 is coupled to a processor bus 110 that transmits data signals between processor 102 and other components in the system 100. The elements of system 100 perform their conventional functions well known in the art.

In one embodiment, processor 102 includes an internal cache memory 104. Depending on the architecture, processor 102 may have a single internal cache or multiple levels of internal caches such as a Level 1 (L1) and a Level 2 L2) cache. A power control unit 106 also resides in processor 102. Alternate embodiments of a power control mechanism 106 can also be used in microcontrollers, embedded processors, graphics devices, DSPs, and other types of logic circuits.

System 100 includes a memory 120. Memory 120 may be a dynamic random access memory (DRAM) device, a static random access memory (SRAM) device, flash memory device, or other memory device. Memory 120 may store instructions and/or data represented by data signals that may be executed by processor 102. A cache memory 104 can reside inside processor 102 that stores data signals stored in memory 120. Alternatively, in another embodiment, the cache memory may reside external to the processor.

A system logic chip 116 is coupled to the processor bus 110 and memory 120. The system logic chip 116 in the illustrated embodiment is a memory controller hub (MCH). The processor 102 communicates to the MCH 116 via a processor bus 110. The MCH 116 provides a high bandwidth memory path 118 to memory 120 for instruction and data storage and for storage of graphics commands, data and textures. The MCH 116 directs data signals between processor 102, memory 120, and other components in the system 100 and bridges the data signals between processor bus 110, memory 120, and system I/O 122. In some embodiments, the system logic chip 116 provides a graphics port for coupling to a graphics controller 112. The MCH 116 is coupled to memory 120 through a memory interface 118. The graphics card 112 is coupled to the MCH 116 through an Accelerated Graphics Port (AGP) interconnect 114.

System 100 uses a proprietary hub interface bus 122 to couple the MCH 116 to the I/O controller hub (ICH) 130. The ICH 130 provides direct connections to some I/O devices. Some examples are the audio controller, firmware hub (flash BIOS) 128, data storage 124, legacy I/O controller containing user input and keyboard interfaces, a serial expansion port such as Universal Serial Bus (USB), and a network controller 134. The data storage device 124 can comprise a hard disk drive, a floppy disk drive, a CD-ROM device, a flash memory device, or other mass storage device. System 100 also includes a power supply that can both source and sink current to the above mentioned components.

For another embodiment of a system, one implementation of a power control mechanism can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip. By including one embodiment of the present invention on the system on a chip, the power control mechanism can power down idle logic blocks to reduce power consumption.

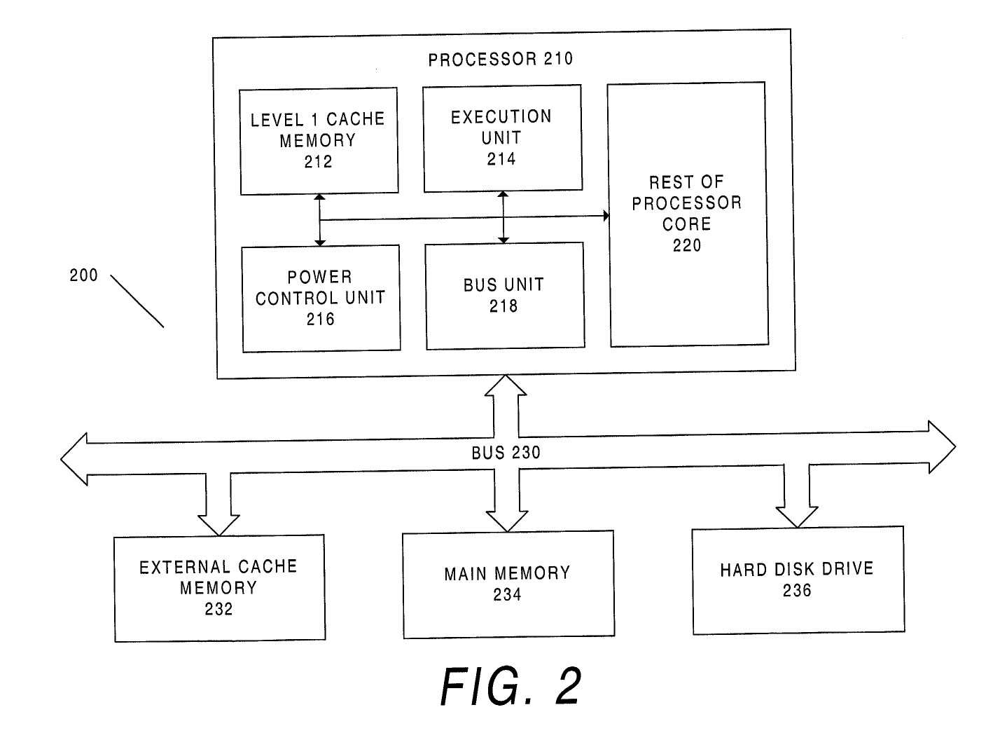

FIG. 2 is one embodiment of a system 200 with a processor including a power control mechanism. In this embodiment, processor 210 is coupled to a bus 230. Also coupled to the bus 230 are various forms of data storage including external cache memory 232, main memory 234, and a hard disk drive 236. The interior of processor 210 of this embodiment includes a Level 1 cache memory 212, an execution unit 214, a power control unit 216, a bus unit 218, and the rest of the processor core 220. These modules communicate to each other via internal processor buses and signals. The Level 1 cache 212 generally has a faster access time than the external memory devices because of its on processor location and its proximity to the execution unit 214. Bus unit 218 is the interface between the processor 210 and the bus 230. Bus unit 218 can interact with the bus 230 and fetch data from the memory storage devices. A number of other units and circuits internal to the processor 210 are grouped here into the block labeled rest of processor core 220 in order to avoid obscuring the present invention. A power supply is also coupled to provide power to the components of system 200.

During normal processor operation, the bus unit 218 fetches data and instructions from the bus 230. Some recently used data may also be stored in the Level 1 cache 212. The execution unit 214 executes the instructions and interacts with the rest of the processor core 220. A power control unit 216 monitors the bus unit and the processor 210 for activity. While the processor is operating, there are often times when the processor activity is decreased or temporarily paused. For instance, if a cache miss occurs when the execution unit 214 is requesting data from the Level 1 cache 212, an external memory read operation would have to be performed. The bus unit 218 would attempt to fetch the needed data from the external cache 232, main memory 234, or hard disk drive 236. The power control mechanism 216 of this embodiment can predict that the certain portions of processor 210 will be idle or stalled while the memory read is being performed.

The power control mechanism 216 can perform a controlled transition from a high power state to a low power state in the processor 210. The high power state can be a high performance condition where the processor 210 is operating at normal capacity, whereas the low power state can be where the processor 210 is operating at less than full capability. For example, the instruction pipeline that provides decoded instructions to the execution unit 214 will be stalled until the needed data is available. During that stall period, the execution unit 214 and certain other circuitry are idle, but still consuming power. The power control mechanism 216 of this embodiment can predict which circuits will be idle for a period and can selectively power down those circuits and units. Thus the power control mechanism 216 can power down or turn off certain functional blocks or circuitry to conserver power. Meanwhile, other units such as the cache memory and the cache control unit can remain active to snoop memory requests, especially in a multiprocessor environment. For this embodiment, the inactive portions of the processor are powered down, but not the entire processor as in some deep powerdown or standby modes. In another embodiment, the power control mechanism 216 can also disable or slow down the internal processor clock signal to inactive or unused circuitry.

Similarly, the power control unit 216 monitors the bus unit 218 and the processor 210 for signs indicating that increased activity on the way. In the example of a cache miss and external memory access, the power control unit 216 can snoop the bus 230 and bus unit 218 to determine whether the status of the memory read. If the power control unit 216 determines that the needed data is incoming from a data storage device, then the processor is transitioned back to a high power state. The power control mechanism 216 can power back up and restore the units and circuits that were powered down during the transition from the high power state to the low power state. For this embodiment, the power control unit 216 conducts the controlled transition back to the high power state early enough that by the time the incoming data arrives at the appropriate location in the processor 210, the processor 210 is ready for normal operation.

Furthermore, the power control mechanism 216 of this embodiment conducts the transitions between the power states in a controlled manner. The rate at which current changes over time is commonly referred to as dI/dt, where dI is the change in current over dt, the change in time. The greater the dI/dt value, the more current is involved. Changing too much current in a circuit in a small time period can be harmful to the circuit as devices may become overstressed or destruct. The amount of power existing processors draw continues to increase while the amount of time available for signal transitions decreases with increasing clock frequencies. This relationship makes it harder to manage the dI/dt rate. As the processor 210 transitions from a high power state to a low power state, a power spike or current transient can occur. Depending on the rate at which power is reduced, the power supply needs to be able to sink excess current. Similarly, as the processor 210 transitions from a low power state to a high power state, another power spike can occur. The power supply needs to be able to supply sufficient current. The power control unit 216 controls the rate at which the power transitions occur such that the power supply and processor 210 are not overstressed. If the voltage tolerance is not met, the processor may not function correctly. The greater the amount of time available to transfer a given amount of current, dI/dt can be decreased. Thus, having the power control unit 216 predict a power state transition as early as possible to allow for a greater transition time can be advantageous.

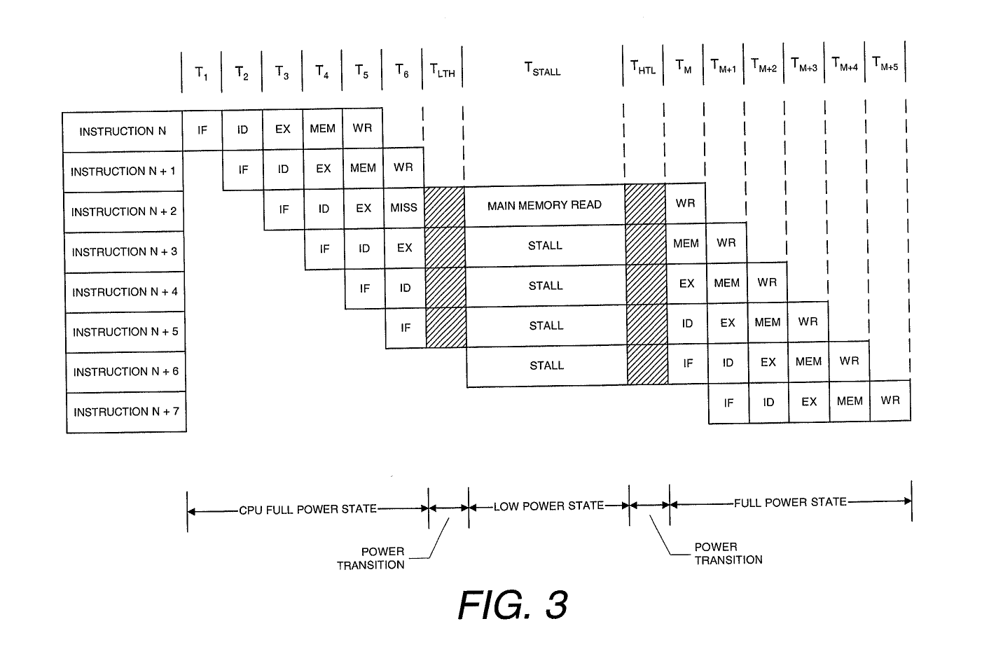

FIG. 3 is a diagram showing a controlled transition of power states. This diagram uses some simplistic CPU execution stages to demonstrate what occurs when the CPU needs to go to main memory because of a cache miss. The embodiment of the present invention comprises of three portions. First, the processor idle time during a memory access is spent in a low power setting. Second, a cache miss signal is used to predict a low power state and to initiate a controlled power state transition from high power to low power to mitigate current transients. Third, the combination of the bus controller knowledge of returning data and a relatively slower bus clock rate is used to initiate a controlled power state transition from low power to high power to mitigate current transients.

The embodiment of FIG. 3 illustrates a couple of different power states and the power transition periods. The processor of this embodiment has a five stage instruction pipeline. The stages are: instruction fetch (IF), instruction decode (ID), instruction execution (EXE), memory access (MEM), and write result (WR). During normal operation, the processor is operating at a full power state. For example, the time periods of T₁ through T₆. Instructions N and N+1 have completed by T₆. However, instruction N+2 experiences a memory access miss at T₆. This miss causes the processor to request a main memory read. Generally, a memory read operation takes a large amount of time relative to the processor clock speed. Thus, the processor cannot continue executing instructions and will be idle until the needed data is available. The pipeline is stalled meanwhile during time T_{STALL}.

Power can be saved if the processor is placed into a low power state while the pipeline is stalled and the processor sitting idle. One embodiment of the invention involves a controlled transition of the processor from a high power state to a low power state. A power control mechanism can be used to control the transition from a high power state to a low power state at time T_{LTH}. This mechanism can also control the transition from the low power state back to the full power state at time T_{HTL}. Predicting the need for a high power state as early as possible can be desirable so that there is sufficient time to restore the processor to a high power state in a controlled fashion without any performance degradation. The processor should be ready to go by the time the data comes back from the memory fetch.

During the state transitions periods T_{LTH} and T_{HTL}, the power control unit determines which circuits and functional units in the processor to power down or to place into a power saving mode. Clock signals and drivers may also be turned off. Depending on the processor architecture, the circuits and units that are powered down may be those that are idle or unused during a pipeline stall. Furthermore, the power control unit executes the state transition in a controlled manner such that the current drawn or sourced at any given time does not create harmful or destructive current transients.

The power control unit of this embodiment also predicts the power state transition. The power control unit can be coupled to signals that indicate or predict an condition allowing a low power state, such as a cache miss. The earlier the power control mechanism determines that a low power state can be used, the earlier the processor can be prepared for a controlled transition to a low power state and possibly greater power savings. The mechanism of this embodiment uses the cache miss signal to predict upcoming processor idle time. Other embodiments can use other similar signals to predict an opportunity for a low power state.

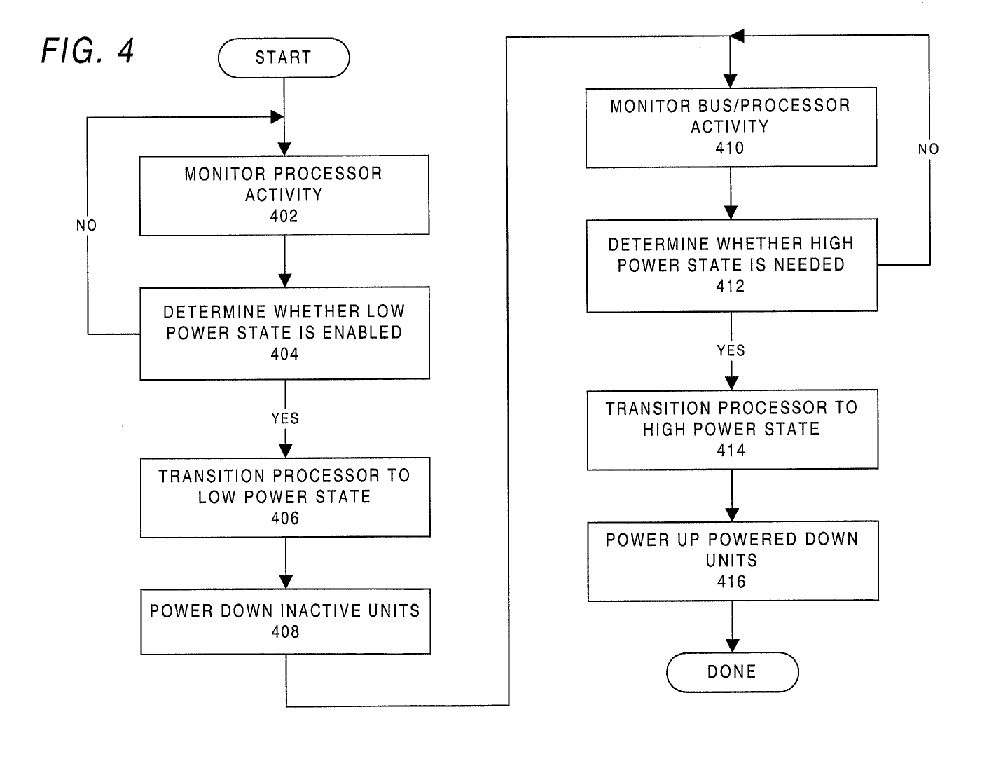

FIG. 4 is flow diagram of one embodiment illustrating the method of predicting processor for a controlled transition of power states. This example generally describes the prediction and power transition processes. At step 402, processor activity is monitored. A power control mechanism determines whether a low power state is enabled at step 404. If a low power state is enabled, the power control mechanism proceeds to transition the processor to a low power state at step 406. If a low power state is not enabled, the power control mechanism continues to monitor processor activity at step 402.

At step 408, inactive units are powered down. Depending on the implementation, internal clocks and other circuitry may also be powered down. Powering down a unit may not involve the complete removal of power to a unit or circuit. For one embodiment, the functional unit may be placed into a power save mode or a standby mode. The power control mechanism of this embodiment conducts the transition from a high power state to a low power state in a controlled manner such that the dI/dt rate is not abrupt. This power control mechanism attempts to distribute the current transition over a longer period of time, thus achieving a smaller dI/dt. When dI/dt is very high, even a small amount of conductance can make the voltage difficult to regulate. Overshoots and/or undershoots can occur in the voltage levels. One embodiment increases the amount of time available for the current transition by predicting the low power state enabling event at an earlier point in time. The earlier the transition is started, the more time there may be available to complete the power state transition. The controlled transition prevents sharp power spikes and lessens the likelihood of damaging circuit devices.

The processor and bus activity are monitored at step 410. Predetermined activity or signals in the processor and on the bus can cause the power control mechanism to react. One predetermined activity may be bus activity or a bus signal to the processor bus unit indicating data incoming to the processor. Another signal may be a hardware interrupt. The power control mechanism at step 412 determines whether the detected activity or signals trigger the need for a high power state in the processor. For instance, a program operation may need to be performed. Similarly, a memory read operation may have completed and the data the processor has been waiting for is arriving. If a high power state is not needed, the bus and processor activity are continued to be monitored. If a high power state is needed, the power control mechanism at step 414 transitions the processor to a high performance state. At step 416, circuits and units that have been powered down are powered back up. This power state transition is conducted in a controlled manner similar to that for the power down. The power control mechanism attempts to limit the dI/dt to a harmless rate. If dI/dt is too large, the circuits and processor may be drawing a large amount of current, which can possibly destroy circuit elements.

In the foregoing specification, the invention has been described with reference to specific exemplary embodiments thereof. It will, however, be evident that various modifications and changes may be made thereof without departing from the broader spirit and scope of the invention as set forth in the appended claims. The specification and drawings are, accordingly, to be regarded in an illustrative rather than a restrictive sense.

What is claimed is:

1. A method comprising:
predicting a first event that allows for lower performance in a processor;
transitioning said processor from a high performance state to a low performance state upon prediction of said first event;
detecting a second event that can utilize greater performance in said processor; and
transitioning said processor from said low performance state to said high performance state upon detection of said second event.

2. The method of claim 1 further comprising detecting a cache miss event.

3. The method of claim 2 wherein said cache miss event causes said processor to fetch data from external memory.

4. The method of claim 3 wherein said detecting a second event comprises monitoring a bus unit for notification of incoming data from a memory fetch.

5. The method of claim 3 wherein said cache miss event causes said processor to stall an instruction pipeline.

6. The method of claim 1 wherein said predicting comprises monitoring processor signals indicating a cache miss, processor reset, or standby.

7. The method of claim 6 wherein said transitioning from a high performance state to a low performance state comprises powering down idle functional units in said processor.

8. The method of claim 1 wherein said high performance state consumes a greater amount of power than said low performance state.

9. The method of claim 8 wherein said transitioning from a high performance state to a low performance state comprises powering down functional units that are not in use.

10. The method of claim 9 wherein said transitioning from said low performance state to said high performance state comprises powering up functional units that have been powered down.

11. The method of claim 8 wherein said transitioning from a high performance state to a low performance state further comprises slowing down an internal processor core clock signal from a normal operating frequency to a lower frequency.

12. The method of claim 11 wherein said transitioning from said low performance state to said high performance state comprises speeding up said internal processor core clock signal to said normal operating frequency.

13. A processor comprising:
a bus unit to fetch data and interact with an external bus;
a cache memory coupled to bus unit, said cache memory to store data;
an execution unit coupled to said cache memory, said execution to execute instructions; and
a power control circuit coupled to said bus unit, said power control circuit to control when said processor transitions between a high power state and a low power state.

14. The processor of claim 13 further comprising an instruction pipeline coupled to said execution unit, said instruction pipeline to provide said instructions to said execution unit.

15. The processor of claim 14 further comprising a processor core clock generator to provide a clock signal to a plurality of functional units within said processor.

16. The processor of claim 15 wherein said power control unit monitors said execution unit and determines whether to transition said processor from said high power state to said low power state.

17. The processor of claim 16 wherein said power control unit powers down idle functional units within said processor when said processor is transitioned from said high power state to said low power state.

18. The processor of claim 17 wherein said power control unit monitors said bus unit, and to transition said processor from said low power state to said high power state when said bus unit indicates data is incoming on said external bus.

19. The processor of claim 18 wherein said power control unit powers up functional units within said processor that have been powered down when said processor is transitioned from said low power state to said high power state.

20. A system comprising:
a memory coupled to a bus;
a memory controller coupled to said bus;
a processor coupled to said bus, said processor including control logic to determine whether a first event has enabled said processor to be in a low performance state, to transition said processor from a high performance state to said low performance state if said first even has occurred; to detect a second event necessitating said processor to be in said high performance state; and to transition said processor from said low performance state to said high performance state if said second event is detected.

21. The system of claim 20 wherein said first event is a cache miss, wherein said cache miss causes said processor to fetch data from said memory.

22. The system of claim 21 wherein said second event is bus activity due to a memory read wherein said memory is sending data to said processor.

23. The system of claim 22 wherein said control logic is monitoring an data fetch unit within said processor for cache misses and wherein said control unit is monitoring a bus unit within said processor for bus activity with said memory.

24. The system of claim 20 further comprising a power supply to provide power to said memory, said memory controller, and said processor.

25. The system of claim 24 wherein said power supply can sink current during a transition from a high power state to a low power state, and wherein said power supply can provide current during a transition from said low power state to said high power state.

26. An article comprising a machine readable medium having stored thereon a plurality of instructions which, if executed by a machine, cause the machine to perform a method comprising:
determining whether a first event has enabled a processor to operate in a low performance state;
transitioning said processor from a high performance state to said low performance state if said first event has occurred;
detecting a second event that can necessitates greater performance in said processor; and
transitioning said processor from said low performance state to said high performance state upon detection of said second event.

27. The article of claim 26 wherein said first event is a cache miss, wherein said cache miss causes said processor to fetch data from memory external to said processor.

28. The article of claim 27 wherein said second event is bus activity resulting from said memory send data to said processor.

29. The article of claim 28 wherein said method further comprises monitoring said processor for cache misses and monitoring a bus for bus activity.

30. The article of claim 26 wherein said machine readable medium is a read only memory (ROM).
